(19) United States
(12) Patent Application Publication
(10) Pub. No.: US 2021/0155793 A1
(43) Pub. Date: May 27, 2021

(54) Thermoplastic Polyester Molding Compositions

(71) Applicant: BASF SE, Ludwigshafen (DE)

(72) Inventors: Jin Huang, Shanghai (CN); Hang Lu, Shanghai (CN); Roland Helmut Kraemer, Lemfoerde (DE); Yao Tao Wang, Shanghai (CN); Martin Weber, Ludwigshafen (DE)

(21) Appl. No.: 16/643,768

(22) PCT Filed: Sep. 3, 2018
(86) PCT No.: PCT/EP2018/073622

§ 371 Date: Mar. 2, 2020

(30) Foreign Application Priority Data
Sep. 6, 2017 (CN) PCT/CN2017/100694

(51) Int. Cl. C08L 67/02; C08L 33/06; C08K 11/00

(52) U.S. Cl. CPC C08L 67/02; C08K 2201/00; C08K 11/00; C08L 33/068

(57) ABSTRACT

The invention relates to thermoplastic polyester molding compositions, comprising polybutylene terephthalate (PBT), poly(1,4-cyclohexanedimethanol terephthalate) (PCT) and epoxy-functionalized compatibilizer, a process for preparing the thermo-plastic polyester molding compositions, and to the use of the molding compositions of the invention for producing parisons, containers, films, tubes, or moldings of any type, and also to the resultant moldings of the invention.

### FIELD OF THE INVENTION

The invention relates to thermoplastic polyester molding compositions, comprising polybutylene terephthalate (PBT), poly(1,4-cyclohexanedimethanol terephthalate) (PCT) and epoxy-functionalized compatibilizer, to a process for preparing the thermoplastic polyester molding compositions, and to the use of the thermoplastic polyester molding compositions of the invention for producing parisons, containers, films, tubes, or moldings of any type, and also to the resultant moldings of the invention.

### BACKGROUND OF THE INVENTION

PBT, as one of the most popular engineering plastics, has made inroads into various applications over the last decades due to its high rigidity and strength, good dimensional stability, low water absorption and high resistance to many chemicals. However, relatively low heat distortion temperature (HDT) and poor toughness has restricted the use of PBT in many high-end applications.

The HDT of PBT can be increased by the incorporation of co-monomers that lead to a higher Tg or by blending with polymers having a higher Tg. The incorporation of co-monomers usually leads to a significant reduction in crystallinity and a loss of chemical resistance. Since PBT is usually produced in large scale equipment, incorporation of co-monomers leads to significantly increased production costs. Therefore, the main focus lies on the approaches to increase the HDT of PBT by blending. There are still quite few commercial successes of polymer blends available in the market due to some unavoidable challenges including limited accessibility of different raw materials, compatibility of different materials and processability etc.

Very often “polymer blend” is still the state-of-art approach for bringing the new desired properties into PBT. Blending of PBT with polycarbonate (PC) leads to formulations with increased HDT and toughness. Due to transesterification between both polymers the level of crystallinity in PBT is reduced, leading to a loss of chemical resistance.

Several PBT-based compounds with other polyesters are known from the literatures, but none of these fulfills all requirements.

CN 105440601A discloses polybutylene terephthalate/poly(1,4-cyclohexanedimethanol terephthalate) (PBT/PCT) blend for electronic device, LED lamps, and vehicles. The PBT/PCT blend has high flowability, heat distortion temperature, and impact strength, and excellent wear resistance, heat resistance, and flame retardancy.

KR2011006103 A discloses a thermoplastic polyester elastomeric resin composite including a base resin, a chain extender, and thermal aging preventer. The base resin comprises: a thermoplastic polyester elastomeric resin; one or more kinds selected from polybuthylene terephthalate, polyethylene terephthalate, polycyclohexylene terephthalate, polyethylene naphthalate, polybutylene naphthalate and polytrimethylene terephthalate; and ethylene-based copolymer including a glycidyl group. The thermoplastic polyester elastomeric resin composite is provided to ensure flexibility, mechanical strength, heat resistance, viscosity suitable for blow molding, excellent melting point and long-term thermal resistance.

However, there is still a desire for alternatives which can balance all of material properties into an excellent level.

### SUMMARY OF THE INVENTION

The objective of the present invention is to provide thermoplastic polyester molding compositions, comprising a) from 51 to 98% by weight of polybutylene terephthalate, b) from 1 to 48% by weight of poly(1,4-cyclohexanedimethanol terephthalate), and c) from 0.05 to 1.8% by weight of epoxy-functionalized compatibilizer, based on the total weight of the composition, which has improved heat distortion temperature and toughness for PBT.

Another objective of the present invention is to provide a process for preparing the thermo-plastic polyester molding compositions.

Another objective of the present invention is to provide the use of the thermoplastic polyester molding compositions of the invention for producing parisons, containers, films, tubes, or moldings of any type.

Another objective of the present invention is further to provide the resultant moldings of the invention.

### DETAILED DESCRIPTION OF THE INVENTION

Unless defined otherwise, all technical and scientific terms used herein have the same meaning as commonly understood by one of ordinary skill in the art to which this invention belongs. Expressions “a”, “an”, “the”, when used to define a term, include both the plural and singular forms of the term.

For clarity, it should be noted that the scope of the present invention encompasses all the definitions and parameters mentioned hereinafter in general terms or specified within areas of preference, in any desired combinations. In addition, for clarity, it should be noted that the compositions, in a preferred embodiment, may be mixtures of components a), b), and c), and also blends that can be produced from these mixtures by means of processing operations, preferably by means of at least one mixing or kneading apparatus, but also products that can be produced from these in turn, especially by extrusion or injection molding.

In one aspect, the present invention provides thermoplastic polyester molding compositions, comprising a) from 51 to 98% by weight of polybutylene terephthalate, b) from 1 to 48% by weight of poly(1,4-cyclohexanedimethanol terephthalate), and c) from 0.05 to 1.8% by weight of epoxy-functionalized compatibilizer, based on the total weight of the composition.

Component a) (Polybutylene terephthalate (PBT))

The thermoplastic molding compositions according to the invention comprise, as component a), preferably from 55 to 95% by weight, and in particular from 58 to 90% by weight, of polybutylene terephthalate, based on the total weight of the composition.

As component a), polybutylene terephthalate may be produced, for example, by transesterification of terephthalate dialkyl esters derived from alcohols of from 1 to 8 carbon atoms, preferably dimethyl terephthalate, with 1,4-butanediol, followed by polycondensation.

The polybutylene terephthalate may be butylene terephthalate homopolymer or the polymer that may be modified with up to 20 mole % of one or more other dicarboxylic acids or alcohols. Examples of possible acidic modifiers are aliphatic dicarboxylic acids of up to 20 carbon atoms, cycloaliphatic dicarboxylic acids or aromatic dicarboxylic acids with 1 or 2 aromatic rings, e.g., adipic acid, sebacic acid, cyclohexanedicarboxylic acid, isophthalic acid or naphthalenedicarboxylic acid. Alcoholic modifiers which may be used are, in particular, the aliphatic and cycloaliphatic glycols of 2 to 10 carbon atoms, such as ethylene glycol, propylene glycol, 1,6-hexanediol, neopentyl glycol, diethylene glycol and 1,4-bishydroxymethylcyclohexane, as well as bisphenols, substituted bisphenols or their reaction products with alkylene oxides.

It may also assist the improvement of the properties if small amounts of trifunctional and poly-functional crosslinking substances such as trimethylolpropane or trimesic acid are present as co-condensed units in the polybutylene terephthalate.

The viscosity number of component a) is generally in the range from 90 to 160 cm³/g, preferably from 100 to 135 cm³/g, measured in a 60/40 (by weight) phenol/1,1,2,2-tetrachloroethane solution, according to ISO 307, 1157, 1628.

The number-average molar mass molecular weight (Mn) of component a) is generally in the range from 2000 to 30000 g/mol, preferably from 5000 to 25000 g/mol, measured determined by means of GPC, PMMA standard Hexafluoroisopropanol, and 0.05 wt % Trifluoroacetic acid-Potassium salt as eluent.

Component b) (Poly(1,4-cyclohexanedimethanol terephthalate) (PCT))

The thermoplastic molding compositions according to the invention comprise, as component b), preferably from 4 to 44% by weight, and in particular from 9 to 41% by weight, of poly(1,4-cyclohexanedimethanol terephthalate), based on the total weight of the composition. As component b), poly(1,4-cyclohexanedimethanol terephthalate) may be produced by well known methods in the art such as those set forth in U.S. Pat. No. 2,901,466 which is incorporated herein by reference. The poly(1,4-cyclohexanedimethanol terephthalate) is commercially available from a number of sources.

The poly(1,4-cyclohexanedimethanol terephthalate) may be formed from a diol and a dicarboxylic acid, in which at least about 80 mole %, more preferably at least about 90 mole %, and especially preferably all of the diol repeat units are derived from 1,4-cyclohexanedimethanol, and at least about 80 mole %, more preferably at least about 90 mole %, and especially preferably all of the dicarboxylic acid repeat units are derived from terephthalic acid.

The poly(1,4-cyclohexanedimethanol terephthalate) may also contain one or more repeat unit derived from hydroxycarboxylic acids, although it is preferred that no such repeat unit be present.

The viscosity number of component b) is generally in the range from 65 to 130 cm³/g, preferably from 70 to 120 cm³/g, measured in a 60/40 (by weight) phenol/1,1,2,2-tetrachloroethane solution, according to ISO 307, 1157, 1628.

The number-average molar mass molecular weight (Mn) of component b) is generally in the range from 2000 to 25000 g/mol, preferably from 5000 to 20000 g/mol, measured determined by means of GPC, PMMA standard Hexafluoroisopropanol, and 0.05 wt % Trifluoroacetic acid-Potassium salt as eluent.

Component c) (epoxy-functionalized compatibilizer)

The thermoplastic molding compositions according to the invention comprise, as component c), preferably from 0.1 to 1.5% by weight, and in particular from 0.3 to 1.2% by weight, of epoxy-functionalized compatibilizer, based on the total weight of the composition.

As component c), The epoxy-functionalized compatibilizer comprises at least two epoxy groups and aromatic and/or aliphatic segments with non-epoxy functional groups, which is made from the polymerization of at least one epoxy-functional (meth)acrylic monomers and non-functional (meth)acrylic acid and/or styrenic monomers. As used herein, the term (meth)acrylic includes both acrylic and methacrylic monomers. Examples of epoxy-functional (meth)acrylic monomers for use in the present invention include both acrylates and methacrylates. Examples of these monomers include, but are not limited to, those containing 1,2-epoxy groups such as glycidyl acrylate and glycidyl methacrylate. Other suitable epoxy-functional monomers include allyl glycidyl ether, glycidyl ethacrylate, and glycidyl itaconate.

Suitable non-functional acrylate and methacrylate monomers for use in the epoxy-functionalized compatibilizer include, but are not limited to, methyl acrylate, ethyl acrylate, n-propyl acrylate, i-propyl acrylate, n-butyl acrylate, s-butyl acrylate, i-butyl acrylate, t-butyl acrylate, n-amyl acrylate, i-amyl acrylate, n-hexyl acrylate, 2-ethylbutyl acrylate, isobornyl acrylate, n-octyl acrylate, 2-ethylhexyl acrylate, n-decyl acrylate, cyclopentyl acrylate, cyclohexyl acrylate, methylcyclohexyl acrylate, methyl methacrylate, ethyl methacrylate, n-propyl methacrylate, i-propyl methacrylate, n-butyl methacrylate, s-butyl-methacrylate, i-butyl methacrylate, t-butyl methacrylate, n-amyl methacrylate, i-amyl methacrylate, n-hexyl methacrylate, 2-ethylbutyl methacrylate, methylcyclohexyl methacrylate, cinnamyl methacrylate, crotyl methacrylate, cyclopentyl methacrylate, cyclohexyl methacrylate, 2-ethoxyethyl methacrylate, and isobornyl methacrylate. Non-functional acrylate and non-functional methacrylate monomers including methyl methacrylate, n-butyl acrylate, n-butyl methacrylate, i-butyl methacrylate, cyclohexyl acrylate, cyclohexyl methacrylate, isobornyl acrylate and isobornyl methacrylate and combinations thereof are particularly suitable. Styrenic monomers for use in the present invention include, but are not limited to, styrene, alpha-methyl styrene, vinyl toluene, p-methyl styrene, t-butyl styrene, o-chlorostyrene, vinyl pyridine, and mixtures thereof. In certain embodiments the styrenic monomers for use in the present invention are styrene and alpha-methyl styrene.

In one embodiment of the invention, the epoxy-functionalized compatibilizer contains about 50% to about 80% by weight, based on the total weight of the monomers, of at least one epoxy-functional (meth)acrylic monomer and between about 20% and about 50% by weight of at least one styrenic monomer. In other embodiments, the epoxy-functionalized compatibilizer contains between about 25% and about 50% by weight of at least one epoxy-functional (meth)acrylic monomer, between about 15% to about 30% by weight of at least one styrenic monomer, and between about 20% and about 60% by weight of at least one non-functional acrylate and/or methacrylate monomer. In yet another embodiment of the invention, the epoxy-functionalized compatibilizer contains about 50% to about 80% by weight, based on the total weight of the monomers, of at least one epoxy-functional (meth)acrylic monomer and between about 15% and about 45% by weight of at least one styrenic monomer and between about 0% to about 5% by weight of at least one non-functional acrylate and/or methacrylate monomer. In still another embodiment, the epoxy-functionalized compatibilizer contains between about 5% and about 25% by weight of at least one epoxy-functional (meth)acrylic monomer, between about 50% to about 95% by weight of at least one styrenic monomer, and between about 0% and about 25% by weight of at least one non-functional acrylate and/or methacrylate monomer.

More specifically, the epoxy-functionalized compatibilizer has an epoxy equivalent weight of from 150 to 3500 g/Eq, preferably from 180 to 2800 g/Eq, and in particular from 220 to 1800 g/Eq, number average epoxy functionality of less than 50, preferably less than 30, and in particular less than 20, weight average epoxy functionality of up to 200, preferably up to 140, and in particular up to 100, and Mw in the range from 2800 to 12000 g/mol, preferably from 3500 to 9000 g/mol, and in particular from 4500 to 8500 g/mol. The epoxy-functionalized compatibilizer may be Joncryl® ADR 4368 (Referring to BASF patent US20040138381).

The epoxy-functionalized compatibilizer may be produced according to standard techniques well known in the art. Such techniques include, but are not limited to, continuous bulk polymerization processes, batch, and semi-batch polymerization processes. Production techniques that are well suited for the epoxy-functionalized compatibilizer are described in U.S. patent application Ser. No. 09/354,350 and U.S. patent application Ser. No. 09/614,402, the entire disclosures of which are incorporated herein by reference. Briefly, these processes involve continuously charging into a reactor at least one epoxy-functional (meth)acrylic monomer, at least one styrenic and/or (meth)acrylic monomer, and optionally one or more other monomers that are polymerizable with the epoxy-functional monomer, the styrenic monomer, and/or the (meth)acrylic monomer.

The proportion of monomers charged into the reactor may be the same as those proportions that go into the epoxy-functionalized compatibilizer discussed above. Thus, in some embodiments, the reactor may be charged with about 50% to about 80%, by weight, of at least one epoxy-functional (meth)acrylic monomer and with about 20% to about 50%, by weight, of at least one styrenic and/or (meth)acrylic monomer. Alternatively, the reactor may be charged with from about 25% to about 50%, by weight, of at least one epoxy-functional (meth)acrylic monomer and with about 50% to about 75%, by weight, of at least one styrenic and/or (meth)acrylic monomer. In other embodiments the reactor may be charged with from about 5% to about 25%, be weight, of at least one epoxy-functional (meth)acrylic monomer and with about 75% to about 95%, by weight, of at least one styrenic and/or (meth)acrylic monomer.

The reactor may also optionally be charged with at least one free radical polymerization initiator and/or one or more solvents. Examples of suitable initiators and solvents are provided in U.S. patent application Ser. No. 09/354,350. Briefly, the initiators suitable for carrying out the process according to the present invention are compounds which decompose thermally into radicals in a first order reaction, although this is not a critical factor. Suitable initiators include those with half-life periods in the radical decomposition process of about 1 hour at temperatures greater or equal to 90° C. and further include those with half-life periods in the radical decomposition process of about 10 hours at temperatures greater or equal to 100° C. Others with about 10 hour half-lives at temperatures significantly lower than 100° C. may also be used. Suitable initiators are, for example, aliphatic azo compounds such as 1-t-amylazo-1-cyanocyclohexane, azo-bis-isobutyronitrile and 1-t-butylazo-cyanocyclohexane, 2,2′-azo-bis-(2-methyl)butyronitrile and peroxides and hydroperoxides, such as t-butylperoctoate, t-butyl perbenzoate, dicumyl peroxide, di-t-butyl peroxide, t-butyl hydroperoxide, cumene hydroperoxide, di-t-amyl peroxide and the like. Additionally, di-peroxide initiators may be used alone or in combination with other initiators. Such di-peroxide initiators include, but are not limited to, 1,4-bis-(t-butyl peroxycarbo)cyclohexane, 1,2-di(t-butyl peroxy)cyclohexane, and 2,5-di(t-butyl peroxy)hexyne-3, and other similar initiators well known in the art. The initiators di-t-butyl peroxide and di-t-amyl peroxide are particularly suited for use in the invention.

The initiator may be added with the monomers. The initiators may be added in any appropriate amount, but preferably the total initiators are added in an amount of about 0.0005 to about 0.06 moles initiator(s) per mole of monomers in the feed. For this purpose initiator is either admixed with the monomer feed or added to the process as a separate feed.

The solvent may be fed into the reactor together with the monomers, or in a separate feed. The solvent may be any solvent well known in the art, including those that do not react with the epoxy functionality on the epoxy-functional (meth)acrylic monomer(s) at the high temperatures of the continuous process described herein. The proper selection of solvent may help to decrease or eliminate the gel particle formation during the continuous, high temperature reaction of the present invention. Such solvents include, but are not limited to, xylene, toluene, ethyl-benzene, Aromatic-100®, Aromatic 150®, Aromatic 200° (all Aromatics available from Exxon), acetone, methylethyl ketone, methyl amyl ketone, methyl-isobutyl ketone, n-methyl pyrrolidinone, and combinations thereof. When used, the solvents are present in any amount desired, taking into account reactor conditions and monomer feed. In one embodiment, one or more solvents are present in an amount of up to 40% by weight, up to 15% by weight in a certain embodiment, based on the total weight of the monomers.

The reactor is maintained at an effective temperature for an effective period of time to cause polymerization of the monomers.

A continuous polymerization process allows for a short residence time within the reactor. The residence time is generally less than one hour, and may be less than 15 minutes. In some embodiments, the residence time is generally less than 30 minutes, and may be less than 20 minutes.

The process for producing the epoxy-functionalized compatibilizer may be conducted using any type of reactor well-known in the art, and may be set up in a continuous configuration. Such reactors include, but are not limited to, continuous stirred tank reactors (“CSTRs”), tube reactors, loop reactors, extruder reactors, or any reactor suitable for continuous operation.

A form of CSTR which has been found suitable for producing the epoxy-functionalized compatibilizer is a tank reactor provided with cooling coils and/or cooling jackets sufficient to remove any heat of polymerization not taken up by raising the temperature of the continuously charged monomer composition so as to maintain a preselected temperature for polymerization therein. Such a CSTR may be provided with at least one, and usually more, agitators to provide a well-mixed reaction zone. Such CSTR may be operated at varying filling levels from 20 to 100% full (liquid full reactor LFR). In one embodiment the reactor is more than 50% full but less than 100% full. In another embodiment the reactor is 100% liquid full.

The continuous polymerization is carried out at high temperatures. In one embodiment, the polymerization temperatures range from about 180 to about 350° C., this includes embodiments where the temperatures range from about 190 to about 325° C., and more further includes embodiment where the temperatures range from about 200 to about 300° C. In another embodiment, the temperature may range from about 200 to about 275° C.

### Customary Additives

The thermoplastic polyester molding compositions can further comprise the other constituents being additives selected by those skilled in the art in accordance with the later use of the products, preferably from at least one of customary additives defined hereinafter, provided that said customary additives don't have negative effect on the thermoplastic polyester molding compositions.

Customary additives used according to the invention are preferably stabilizers, demolding agents, UV stabilizers, thermal stabilizers, gamma ray stabilizers, antistats, flow aids, flame retardants, elastomer modifiers, acid scavengers, emulsifiers, nucleating agents, plasticizers, lubricants, dyes or pigments. These and further suitable additives are described, for example, in Gächter, Müller, Kunststoff-Additive [Plastics Additives], 3rd edition, Hanser-Verlag, Munich, Vienna, 1989 and in the Plastics Additives Handbook, 5th Edition, Hanser-Verlag, Munich, 2001. The additives can be used alone or in a mixture, or in the form of masterbatches. Stabilizers used are preferably sterically hindered phenols or phosphites, hydroquinones, aromatic secondary amines such as diphenylamines, substituted resorcinols, salicylates, benzotriazoles and benzophenones, and also variously substituted representatives of these groups or mixtures thereof.

Preferred phosphites are selected from the group of tris(2,4-di-tert-butylphenyl) phosphite (Irgafos® 168, BASF SE, CAS 31570-04-4), bis(2,4-di-tert-butylphenyl)pentaerythrityl diphosphite (Ultranox® 626, Chemtura, CAS 26741-53-7), bis(2,6-di-tert-butyl-4-methylphenyl)pentaerythrityl diphosphite (ADK Stab PEP-36, Adeka, CAS 80693-00-1), bis(2,4-dicumylphenyl)pentaerythrityl diphosphite (Doverphos® S-9228, Dover Chemical Corporation, CAS 154862-43-8), tris(nonylphenyl) phosphite (Irgafos® TNPP, BASF SE, CAS 26523-78-4), (2,4,6-tri-t-butylphenol)-2-butyl-2-ethyl-1,3-propanediol phosphite (Ultranox® 641, Chemtura, CAS 161717-32-4) and Hostanox® P-EPQ.

The phosphite stabilizer used is especially preferably at least Hostanox® P-EPQ (CAS No. 119345-01-6) from Clariant International Ltd., Muttenz, Switzerland. This comprises tetrakis(2,4-di-tert-butylphenyl)-1,1-biphenyl-4,4′-diyl bisphosphonite (CAS No. 38813-77-3), which can especially be used with very particular preference as component d) in accordance with the invention.

Acid scavengers used are preferably hydrotalcite, chalk, zinc stannate or boehmite. Preferred demolding agents used are at least one selected from the group of ester wax(es), pentaerythrityl tetrastearate (PETS), long-chain fatty acids, salt(s) of the long-chain fatty acids, amide derivative(s) of the long-chain fatty acids, montan waxes and low molecular weight polyethylene or polypropylene wax(es), and ethylene homopolymer wax(es).

Preferred long-chain fatty acids are stearic acid or behenic acid. Preferred salts of long-chain fatty acids are calcium stearate or zinc stearate. A preferred amide derivative of long-chain fatty acids is ethylenebisstearylamide (CAS No. 130-10-5). Preferred montan waxes are mixtures of short-chain saturated carboxylic acids having chain lengths of 28 to 32 carbon atoms. Nucleating agents used are preferably sodium phenylphosphinate or calcium phenylphosphinate, alumina (CAS No. 1344-28-1) or silicon dioxide.

Plasticizers used are preferably dioctyl phthalate, dibenzyl phthalate, butyl benzyl phthalate, hydrocarbon oils or N-(n-butyl)benzenesulphonamide.

The preparation of the compositions according to the present invention for further use or application takes place by mixing components a), b), and c) to be used as educts in at least one mixing tool. Blends are obtained as intermediate products and based on the compositions according to the present invention. These blends can exist either exclusively of the components a), b), and c), or include, however, in addition, to the components a), b), and c) even other components and also the above additives. In the former case the components a), b), and c) are to be varied within the scope of the given amount areas in such way that the sum of all weight percent always results in 100.

The process for the preparation of the blends is described as followed: (1) PBT and PCT resin were dried at 120 to 150° C. under 1 to 2 hours, controlling the moisture<0.05%; (2) the typical range of the compositions by weight: PBT resin, PCT resin, and epoxy-functionalized compatibilizer, were added to a twin-screw extruder, pelletized and dried, to obtain the blends; (3) the processing conditions in step (2): processing temperatures in the range of 280 to 300° C., screw speed of 200 to 400 rpm, residence time of 1 to 3 minutes. The above additives can be incorporated during or after the preparation of the blends.

The present invention also relates to the use of the thermoplastic polyester molding compositions according to the invention for producing parisons, containers, films, tubes, or moldings of any type, for production of products resistant to heat distortion, preferably electric or electronic assemblies and components or the components/applications in automotive industries, especially preferably optoelectronic products, which require the materials having improved heat distortion temperature and toughness.

The present invention also relates to the resultant moldings from the thermoplastic polyester molding compositions according to the invention.

The examples given below are intended to illustrate the invention without restricting it.

### EXAMPLES

### Component a):

Ultradur® B 4500 from BASF (PBT with viscosity number to DIN 53728 of 130 cm³/g, number-average molar mass molecular weight (Mn) of 23200 g/mol)

### Component b):

PCT Skypura 0302 from SK Chemicals (PCT with viscosity number of DIN 53728 of 85 cm³/g, number-average molar mass molecular weight (Mn) of 12700 g/mol)

### Component c):

Joncryl®0 ADR 4368 from BASF (Mw=6800 g/mol, epoxy equivalent weight 280 g/Eq, branched epoxy-functionalized compatibilizer)

Araldite GT 7077 from Huntsman (epoxy equivalent 1490-1640 g/Eq, linear epoxy-functionalized compatibilizer).

Heat distortion temperature (HDT) is tested on Compact 6(Coesfeld, Germany) ISO 75-1/-2; Tensile strength and E-modulus is measured on Z050(Zwick Roell, Germany), according to ISO 527-2;

Strain at break is characterized with Z050(Zwick Roell, Germany), according to ISO 527-2; Notched charpy is done by HIT25P(Zwick Roell, Germany), according to ISO 179/1eA; Unnotched charpy is measured on HIT25P(Zwick Roell, Germany), according to ISO 179/1eU; The process for the preparation of the blends from the following ingredients in Table 1 is described as followed: (1) PBT and PCT resin were pre-dried at 120-150° C. under 1-2 hours, controlling the moisture<0.05%. (2) PBT resin, PCT resin, and Joncryl® ADR 4368 or Araldite GT 7077 (according to the composition shown in Table 1, part by weight) were added to a twin-screw extruder, pelletized and dried, to obtain the blends with the processing temperatures of 285° C., screw speed of 300 rpm and residence time of 75 seconds.

TABLE 1

| | 1 | 2 comparative | 3 comparative | 4 comparative | 5 | 6 | 7 comparative |
|---|---|---|---|---|---|---|---|
| Ingredient | control | example | example | example | example | example | example |
| PBT Ultradur B 4500 | 100 | 90 | 80 | 60 | 79.75 | 59 | 58 |
| PCT Skypura 0302 | | 10 | 20 | 40 | 20 | 40 | 40 |
| Joncryl ® ADR 4368 | | | | | 0.25 | 1 | |
| Araldite ® GT 7077 | | | | | | | 2 |

Thermal Properties-Heat distortion temperature

| | | | | | | | |
|---|---|---|---|---|---|---|---|
| HDT (° C., 1.8 MPa) | 61 | 61 | 67 | 76 | 81 | 70 | 76 |

Mechanical Properties

| | | | | | | | | |
|---|---|---|---|---|---|---|---|---|
| Tensile | Tensile | 60.1 | 59.4 | 59.9 | 54.2 | 58.7 | 60.7 | 52.1 |
| | strength(MPa) | | | | | | | |
| | Strain at break(%) | 7.54 | 4.06 | 2.76 | 2.76 | 3.19 | 4.27 | 2.3 |
| | E-modulus(MPa) | 2720 | 2820 | 2810 | 2690 | 2690 | 2590 | 2760 |
| Charpy | Notched(KJ/m²) | 3.29 | 3.33 | 3.01 | 2.81 | 3.11 | 3.9 | 2.92 |
| | Unnotched(KJ/m²) | Unbreak | 116.2 | 60.5 | 33.2 | Unbreak | Unbreak | 32.88 |

1. A thermoplastic polyester molding composition, comprising a) from 51 to 98% by weight of polybutylene terephthalate, b) from 1 to 48% by weight of poly(1,4-cyclohexanedimethanol terephthalate), and c) from 0.05 to 1.8% by weight of an epoxy-functionalized compatibilizer, based on the total weight of the composition.

2. The composition according to claim 1, wherein component a) is produced by transesterification of terephthalate dialkyl esters derived from alcohols of from 1 to 8 carbon atoms, followed by polycondensation.

3. The composition according to claim 1, wherein component a) is butylene terephthalate homopolymer, or optionally modified with up to 20 mole % of one or more other dicarboxylic acid or alcohol.

4. The composition according to claim 1, wherein a viscosity number of component a) is in a range from 90 to 160 cm³/g, measured in a phenol/1,1,2,2-tetrachloroethane solution with weight ratio of 60/40, according to ISO 307, 1157, 1628.

5. The composition according to claim 1, wherein a number-average molar mass molecular weight (Mn) of component a) is in a range from 2000 to 30000 g/mol, measured determined by means of GPC, PMMA standard Hexafluoroisopropanol, and 0.05 wt % Trifluoroacetic acid-Potassium salt as eluent.

6. The composition according to claim 1, wherein component b) is formed from a diol and a dicarboxylic acid, in which at least 80 mole %, of the diol repeat units are derived from 1,4-cyclohexanedimethanol, and at least 80 mole % of the dicarboxylic acid repeat units are derived from terephthalic acid.

7. The composition according to claim 1, wherein component b) further comprises one or more repeat unit derived from a hydroxycarboxylic acid.

8. The composition according to claim 1, wherein a viscosity number of component b) is in a range from 65 to 130 cm³/g, measured in a phenol/1,1, 2,2-tetrachloroethane solution with weight ratio of 60/40, according to ISO 307, 1157, 1628.

9. The composition according to claim 1, wherein a number-average molar mass molecular weight (Mn) of component b) is in a range from 2000 to 25000 g/mol, measured determined by means of GPC, PMMA standard Hexafluoroisopropanol, and 0.05 wt % Trifluoroacetic acid-Potassium salt as eluent.

10. The composition according to claim 1, wherein component c) comprises at least two epoxy groups and aromatic and/or aliphatic segments with non-epoxy functional groups, which is made from the polymerization of at least one epoxy-functional (meth)acrylic monomer and non-functional (meth)acrylic acid and/or styrenic monomers.

11. The composition according to claim 1, wherein component c) has an epoxy equivalent weight of from 150 to 3500 g/Eq, number average epoxy functionality of less than 50, weight average epoxy functionality of up to 200, and Mw in a range from 2800 to 12000 g/mol.

12. The composition according to claim 1, further comprising at least one additive selected from the group consisting of stabilizers, demolding agents, UV stabilizers, thermal stabilizers, gamma ray stabilizers, antistats, flow aids, flame retardants, elastomer modifiers, acid scavengers, emulsifiers, nucleating agents, plasticizers, lubricants, dyes, and pigments.

13. A process for preparing the thermoplastic polyester molding composition according to claim 1 comprising mixing corresponding components a), b), and c).

14. The thermoplastic polyester molding composition according to claim 1 for use in producing parisons, containers, films, tubes, or moldings.

15. The thermoplastic polyester molding composition according to claim 1 for use in producing a product resistant to heat distortion.

16. A molding prepared from the thermoplastic polyester molding composition according to claim 1.

17. The composition according to claim 1 comprising from 55 to 95% by weight polybutylene terephthalate, from 4 to 44% by weight poly(1,4-cyclohexanedimethanol terephthalate), and from 0.1 to 1.5% by weight of the epoxy-functionalized compatibilizer, based on the total weight of the composition.

18. The composition according to claim 1 comprising from 58 to 90% by weight polybutylene terephthalate, from 9 to 41% by weight poly(1,4-cyclohexanedimethanol terephthalate), and from 0.3 to 1.2% by weight of the epoxy-functionalized compatibilizer, based on the total weight of the composition.

19. The composition according to claim 16 wherein the product resistant to heat distortion is an electric or electronic assembly, an electric or electronic component, or an optoelectronic product.
